(19) United States
(12) Patent Application Publication
(10) Pub. No.: US 2006/0092644 A1
(43) Pub. Date: May 4, 2006

(54) Small package high efficiency illuminator design

(76) Inventors: Thye Linn Mok, Bukit Mertajam (MY); Meng Ee Lee, Penang (MY); Chien Chai Lye, Penang (MY); Kheng Leng Tan, Penang (MY)

Correspondence Address: AGILENT TECHNOLOGIES, INC.;INTELLECTUAL PROPERTY ADMINISTRATION, LEGAL DEPT., P.O. BOX 7599, M/S DL429, LOVELAND, CO, 80537-0599, US

(21) Appl. No.: 10/975,823

(22) Filed: Oct. 28, 2004

(51) Int. Cl. F21V 5/00

(52) U.S. Cl. 362/327; 362/800; 257/98

(57) ABSTRACT

Disclosed are systems and methods which provide an illuminator configuration in which an optical element is provided integral with a reflector component. Embodiments provide an LED encapsulation optical element having a boundary with a surrounding medium, such as air, which avoids or minimizes total internal reflection phenomena. Such an LED encapsulation optical element is formed integral with a reflector component in order to ensure proper relative placement of the LED light source, optical element, and reflector component and/or to facilitate rapid and predictable mechanical assembly of an illuminator. Plated through holes may be disposed in a substrate beneath the LED light source to dissipate heat from the LED light source, prolonging the life of the LED light source and/or the encapsulation material.

### TECHNICAL FIELD

The invention relates generally to illuminators, more specifically, to high efficiency illuminators implementing a small package design.

### BACKGROUND OF THE INVENTION

Illumination devices have been used for many years to provide illuminators suitable for use in various situations. For example, portable battery powered hand held flashlights or torches are very common. As technology has progressed with respect to light sources, different configurations and implementations of illumination devices have proliferated. For example, with the development of white light emitting diodes (LEDs), illumination devices using extremely low power and which may present a relatively small configuration have become widely available.

Because of their relative small size and low power consumption, illumination devices implementing LEDs as a light source have been integrated into various host devices which do not typically provide an illuminator. For example, key fobs (e.g., vehicle remote keyless entry transmitters attached to a key ring) and cellular telephones are beginning to include illuminators having an LED light source for use as a portable flashlight. However, LED devices used in the past have not provided a solution which may be easily integrated, such as by automated “pick-and-place” machinery, into an illumination device and which provides optimized light output and columniation.

Directing attention to FIG. 1, a cross section from the side of an exemplary prior art configuration of an illumination device having an LED light source, such as may be used as an illuminator on a cellular telephone, is shown as illuminator 100. Illuminator 100 includes reflector 110, shown to comprise a cylindrical body providing reflective inner surface 111 formed as a frustum of a cone, disposed upon substrate 130, such as may comprise a printed circuit board or other planer structure. Illuminator 100 further includes LED 120, shown to comprise LED chip or die 121 incarcerated in encapsulation 122. Encapsulation 122 provides a protective housing for LED chip 121 and bond wires (not shown) associated therewith. Encapsulation 122 is formed as a cylinder having a flat top surface in order to facilitate mechanized assembly of illuminator 100, such as using pick-and-place machines. Lens 140 is included to further calumniate the light emitted by LED 120 and which is reflected by reflector 110.

The foregoing illuminator configuration has been found to provide less than optimized light output and columniation for a number of reasons. It is often difficult to properly position reflector 110 and/or LED 120 on substrate 130 such that the relative positions of reflector 110 and LED 120 result in the desired columniation of light. For example, LED 120 may be disposed off-center within reflector 110. The foregoing results in a beam of light which is not as well defined as is desired, which exhibits undesired edge phenomena associated with the beam, which has non-uniform illumination within the beam, etcetera. Moreover, although providing a package configuration well suited for mechanized assembly, encapsulation 122 presents surfaces disposed such that critical angles are present with respect to a significant amount of light radiated by LED chip 121 resulting in light lost due to the total internal reflection phenomena. Specifically, light radiated by LED chip 121 and passing through the media of encapsulation 122 into the surrounding air is refracted in accordance with Snells' Law. However, some portion of the light radiated by LED chip 121 strikes the interface between encapsulation 122 and the surrounding air at a critical angle (or an angle more acute than the critical angle) associated with the boundary of these 2 media of differing refractive indices, thereby resulting in the light being reflected back into encapsulation 122 rather than passing into the air surrounding encapsulation 122.

### BRIEF SUMMARY OF THE INVENTION

The present invention is directed to systems and methods which provide an illuminator configuration in which an optical element is provided integral with a reflector component. Embodiments of the present invention provide an LED encapsulation optical element providing a boundary with a surrounding medium, such as air, which avoids or minimizes total internal reflection phenomena. Such an LED encapsulation optical element is formed integral with a reflector component according to embodiments of the invention in order to ensure proper relative placement of the LED light source, optical element, and reflector component and/or to facilitate rapid and predictable mechanical assembly of an illuminator. Plated through holes may be disposed in a substrate beneath the LED light source to dissipate heat from the LED light source, prolonging the life of the LED light source and/or the encapsulation material.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWING

For a more complete understanding of the present invention, reference is now made to the following descriptions taken in conjunction with the accompanying drawing, in which:

FIG. 1 shows a cross-section view of a typical LED illuminator configuration of the prior art;

FIG. 2 shows a cross-section view of a LED illuminator of an embodiment of the present invention;

FIG. 3 shows a plan view of the LED illuminator of FIG. 2; and

FIG. 4 shows a cross-section view of a LED illuminator of an alternative embodiment of the present invention.

### DETAILED DESCRIPTION OF THE INVENTION

Directing attention to FIG. 2, illuminator 200 adapted according to an embodiment of the present invention is shown in a cross section view from the side. Illuminator 200 of the illustrated embodiment may be utilized as an illuminator device disposed on a host system, such as a cellular telephone or other system having a battery or similar power supply, for use as a flashlight, for example. Of course, illuminator 200 may be utilized in any number of other configurations, such as in a light fixture disposed in a home or office for general illumination, to provide illumination of objects such as signs, computer displays, etcetera, to provide light signaling such as in traffic lights, navigation markers on ships and planes, etcetera, and the like.

Illuminator 200 of the illustrated embodiment includes LED 220, shown to comprise LED chip or die 221 incarcerated in encapsulation 222. LED 220 is disposed upon substrate 230, such as may comprise a printed circuit board or other planer structure. LED chip 221 may comprise any number of LED emitter embodiments, including single or multiple LED emitters composed of materials such as InGaN, AlInGaP, GaP, GaN, GaAs, AlGaAs, SiC, etcetera. Encapsulation 222 may be comprised of any number of formable materials which pass light of a wavelength emitted by LED chip 221, such as clear polymeric resins epoxy resins, silicone, polyurethanes, acetates, acrylates, acrylics, etcetera.

Encapsulation 222 provides a protective housing for LED chip 221 and bond wires (not shown) associated therewith. Additionally, encapsulation 222 may provide a structure upon which material may be placed to facilitate radiation of a desired color of light, such as a yellow phosphor where LED chip 221 emits a blue light and a white light is desired. Encapsulation 222 is formed as an integrated structure which includes an optical element, shown here as optical dome 224, and a reflector component, shown here as reflector surface 223. For example, encapsulation 222 may be formed from a liquid, or otherwise sufficiently moldable, material introduced into a negative mold defining a desired optical element and reflector component shape as an integrated body. Additionally or alternatively, encapsulation 222 may be formed from a solid, or otherwise hardened, material through removal of portions thereof to define a desired optical element and reflector component shape as an integrated body.

Optical dome 224 of the illustrated embodiment provides a surface shaped to avoid or minimize the effects of total internal reflection phenomena. Specifically, the surface of optical dome 224 of embodiments of the invention is shaped such that no portion of the light radiated by LED chip 221 strikes the interface between optical dome 224 and the surrounding air at a critical angle (or an angle more acute than the critical angle) associated with the boundary of these 2 media of differing refractive indices. Accordingly, no light radiated by LED chip 221 and propagating into optical dome 224 is reflected back into encapsulation 222, but rather all such light passes into the air surrounding optical dome 224.

Optical dome 224 of embodiments of the invention is additionally or alternatively shaped to columniate light radiated by LED chip 221 to provide a wave front propagating away from LED 220 in a direction substantially orthogonal to substrate 230. According to the illustrated embodiment, optical dome 224 is provided a lens shaped surface to provide the aforementioned columniation. For example, the surface of optical dome 224 providing an interface with air surrounding LED 220 is shaped as a convex lens such that a substantial portion of light radiated by LED chip 221 is refracted and directed to propagate substantially orthogonally with respect to substrate 230.

Reflector surface 223 provides a base for supporting a reflective surface, such as reflective surface 211, and is shaped and spaced from LED chip 221 and optical dome 224 to facilitate columniation of light from illuminator 200. For example, reflective surface 211 may comprise a metalized, or otherwise light reflective, coating deposited upon reflector surface 223 such as nickel, chrome, silver, and/or the like. Through cooperation of the shape of optical dome 224 and reflector surface 223, a portion of light which is not otherwise directed to propagate substantially orthogonally with respect to substrate 230 by optical dome 224 impinges upon reflective surface 211 and is reflected to propagate substantially orthogonally with respect to substrate 230. Through careful shaping of optical dome 224 and reflector surface 223 and by properly spacing optical dome 224 and reflector surface 223 light output by illuminator 200 may be optimized and/or desired beam attributes (e.g., shape, width, edge phenomena, even illumination within the beam, etcetera) may be attained.

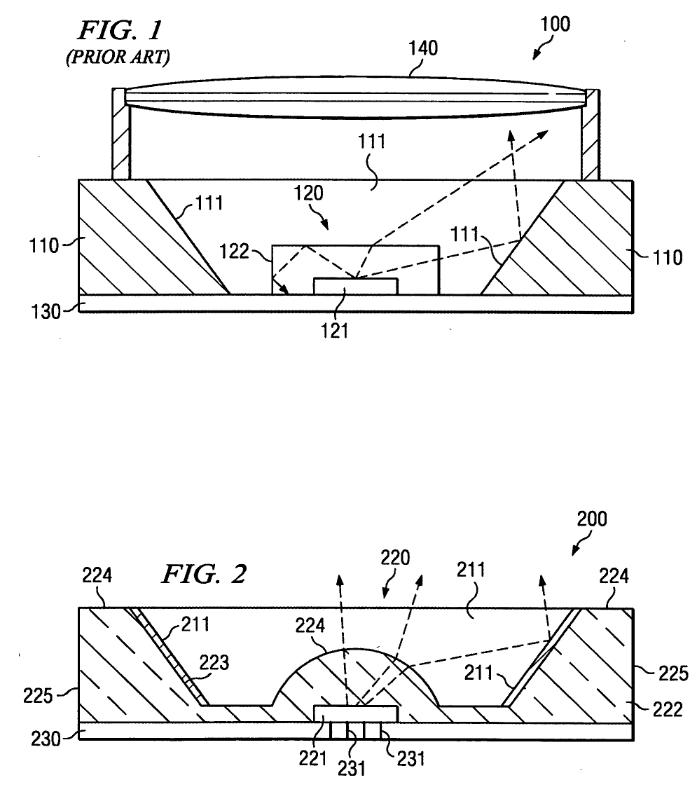

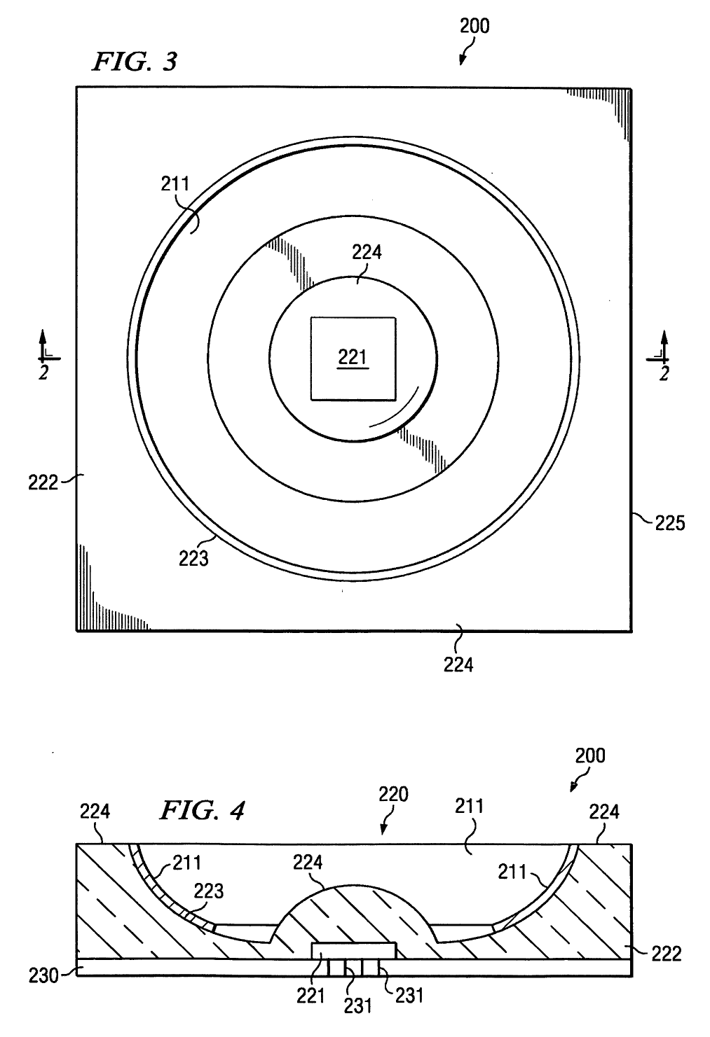

As may be more readily appreciated from the plan view of FIG. 3, because reflector surface 223 is formed integral with optical dome 224 as encapsulation 222, which incarcerates LED chip 221, the relative placement of reflective surface 211, disposed upon reflector surface 223, optical dome 224, and LED chip 221 is precisely controlled to optimize light output and/or columniation. Such precise placement is not possible in automated mass manufacturing methods as are typically employed with respect to illuminator 100 of FIG. 1, wherein reflector 110 and LED 120 are discrete components.

Although shown in the embodiment of FIG. 2 as being formed as a frustum of a cone, reflector surface 223 may be formed in a number of different shapes determined to provide a desired level of light output and/or columniation. For example, reflector surface 223 may be provided in a parabolic shape, as shown in FIG. 4, if desired. Precise relative placement of the optical element and reflector component according to embodiments of the present invention facilitates the use of reflector surface shapes, such as the aforementioned parabolic shape, which provide further optimization of light output and/or columniation. Such reflector shapes may not be practical in configurations wherein the LED and reflector are separate, such as that of FIG. 1, because the reflector is provided in a shape (e.g., frustum of a cone) which is tolerant to imprecise relative placement of these components.

LED 220 of embodiments of the invention allows for mechanized assembly of illuminator 200, such as using pick-and-place machines. For example, horizontal surface 224 and/or vertical surface 225 of encapsulation 222 of the illustrated embodiment facilitate reliable interfacing with pick-and-place mechanisms. Accordingly, although optical dome 224 of the illustrated embodiment presents a compound curved surface which is often difficult to reliably interface with pick-and-place mechanisms, encapsulation 222 presents surfaces more readily interfaced with such mechanisms. Of course, optical dome 224 of embodiments of the invention may interface with the aforementioned pick-and-place mechanisms where such mechanisms are adapted to interface with the surface presented thereby and/or where optical dome 224 is shaped to interface with such mechanisms.

The illustrated embodiment of illuminator 200 disposes an optical element, here optical dome 224, within a corresponding reflector component, here reflector surface 223, eliminating a need for an external optical element, such as lens 140 of FIG. 1. Accordingly, embodiments of the present invention provide a low profile illuminator assembly, such as may be particularly desirable for integration into various host devices which do not typically provide an illuminator, such as key fobs (e.g., vehicle remote keyless entry transmitters attached to a key ring), cellular telephones, personal digital assistants (PDAs), clothing (e.g., caps, hats, wrist bands, and belts), and the like. Moreover, the integration of the optical element and reflector component of embodiments of the present invention further provides a configuration which is resistant to damage, such as removal or repositioning of an optical element, thereby facilitating reliable use in highly portable situations, such as may be experienced when integrated with the foregoing host devices.

LED chip 221 of embodiments of the invention will generate an appreciable amount of heat during operation thereof. Heat generated by LED chip 221 may degrade the material of encapsulation 222 and/or shorten the operational life of LED chip 221. Accordingly, embodiments of illuminator 200 include plated through holes 231 disposed in substrate 230 beneath LED chip 221. Plated through holes 231 provide heat conduction from LED chip 221 through substrate 230, such as may comprise a printed circuit board material such as FR4. The heat conducted by plated through holes 231 may be radiated by an exposed end of the plated through holes, may be transferred to a heat sink disposed on the underside of substrate 230, may be transferred to other components disposed on the underside of substrate 230, etcetera.

Plated through holes 231 may be provided in any number beneath LED chip 221. However, embodiments of the invention utilize 10 or fewer plated through holes for a typical LED chip. The plated through holes may be disposed in any number of configurations, which do not otherwise interfere with the electronics of illuminator 200, such as evenly spaced beneath LED chip 221 or more densely spaced in juxtaposition with “hot spots” of LED chip 221.

Although the present invention and its advantages have been described in detail, it should be understood that various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one will readily appreciate from the disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. An illuminator system comprising:
a light source;
an integrated optical element and reflector component, said integrated optical element and reflector component encapsulating said light source, wherein said optical element is disposed within said reflector component.

2. The system of claim 1, wherein said light source comprises a light emitting diode (LED).

3. The system of claim 1, wherein said light source is encapsulated within a portion of said optical element.

4. The system of claim 1, wherein said optical element comprises an optical dome.

5. The system of claim 1, wherein said optical element is shaped to minimize the effects of total internal reflection phenomena with respect to light emitted by said light source.

6. The system of claim 1, wherein said optical element is shaped to form a convex lens.

7. The system of claim 1, wherein said reflector component is shaped as a frustum of a cone.

8. The system of claim 1, wherein said reflector component is shaped to provide parabolic surface portions.

9. The system of claim 1, further comprising:
a substrate coupled to said integrated optical element and reflector component; and
a plurality of plated through holes in said substrate and disposed in juxtaposition with said light source.

10. A method for providing an illuminator, said method comprising:
forming an integrated optical element and reflector component, wherein said optical element is disposed within at least a portion of said reflector component; and
incarcerating a light source within said integrated optical element and reflector component.

11. The method of claim 10, further comprising:
disposing said integrated optical element and reflector component, having said light source encapsulated therein, upon a substrate using a mechanized process.

12. The method of claim 10, further comprising:
coating at least a portion of said reflector component with a material which reflects light of a wavelength emitted by said light source.

13. The method of claim 10, further comprising:
shaping said optical element and said reflector component to cooperate to optimize light output by said illuminator.

14. A low profile light emitting diode (LED) lighting system, said system comprising:
a LED light source;
an encapsulation member encapsulating said LED light source, wherein said encapsulation member is formed from a homogeneous material and includes an optical dome and a reflector surface, wherein said reflector surface surrounds said optical dome.

15. The system of claim 14, wherein said optical dome is shaped to minimize the effects of total internal reflection phenomena with respect to light emitted by said LED light source.

16. The system of claim 14, wherein said optical dome is shaped to form a convex lens.

17. The system of claim 14, wherein said reflector surface is shaped as a frustum of a cone.

18. The system of claim 14, wherein said reflector surface is shaped as a parabolic surface.

19. The system of claim 14, further comprising:
a plurality of plated through holes in a substrate and disposed in juxtaposition with said LED light source.

20. The system of claim 14, wherein a surface of said encapsulation member is adapted to interface with an automated assembly machine.

21. The system of claim 14, wherein said LED lighting system is disposed on a host selected from the group consisting of:
a key fob;
a cellular telephone;
a personal digital assistant (PDA); and
an article of clothing.
